(19) United States
(12) Patent Application Publication
(10) Pub. No.: US 2010/0241635 A1
(43) Pub. Date: Sep. 23, 2010

(54) System and Method for Quantifying and Calculating the Difference Between Occupations

(76) Inventors: Katherine DEROSEAR, Midlothian, VA (US); Jason CERNANSKY, Brooklyn, NY (US)

Correspondence Address: PITTS AND BRITTIAN P C, P O BOX 51295, KNOXVILLE, TN, 37950-1295, US

(21) Appl. No.: 12/721,936

(22) Filed: Mar. 11, 2010

Related U.S. Application Data
(60) Provisional application No. 61/161,633, filed on Mar. 19, 2009.

(51) Int. Cl. G06F 17/30

(52) U.S. Cl. 707/749; 707/E17.044

(57) ABSTRACT

Described is a system and method for quantifying and calculating a similarity between two occupations utilizing information provided by the Occupational Information Network (“the O*NET). More specifically, the system is in communication with the O*NET, which rates a plurality of occupations in terms of a plurality of quantifying values. The system accesses the quantifying values assigned to each of the two occupations and calculates the similarity therebetween.

### CROSS-REFERENCE TO RELATED APPLICATIONS

This application claims the benefit of U.S. Provisional Patent Application No. 61/161,633, filed Mar. 19, 2009.

### STATEMENT REGARDING FEDERALLY SPONSORED RESEARCH OR DEVELOPMENT

Not Applicable

### BACKGROUND OF THE INVENTION

1. Field of the Invention

This invention pertains to a system and method that quantifies and calculates the difference between two or more occupations with respect to one or more categories defined and provided by the Occupational Information Network.

2. Description of the Related Art

Conventional economic, education, and workforce development systems compare occupations for the purpose of determining whether one occupation would be a satisfactory substitution for another. One such conventional system is disclosed and discussed in U.S. Pat. No. 7,480,659 issued to Chmura et al. This system compares two occupations by first defining each occupation in terms of six vectors. Each vector represents the occupation in terms of one of six categories, the categories being abilities, knowledge, skills, interests, tasks, and work activities. Next, the system calculates an angular cosine distance between the two vectors that represent the two occupations for each category. Stated differently, the system calculates six distances. The system calculates each angular cosine distance using a “cosine distance formula”, which is defined as follows:

$$\frac{{\sum }_{i = 1}^{\vert T \vert} f ( {v}_{i} ) \cdot f ( {w}_{i} )}{\sqrt{{\sum }_{i = 1}^{\vert T \vert} {f ( {v}_{i} )}^{2}} \cdot \sqrt{{\sum }_{i = 1}^{\vert T \vert} {f ( {w}_{i} )}^{2}}}$$

whereby v represents one occupation vector and w represents another occupation and T represents the complete set of attributes in a particular category. Further, the function ƒ represents a dampening function, which is log.

The system then combines the six calculated angular cosine distances with equal weights (1/6) such that the similarity of the two occupations is represented as follows:

$$OccupationSim ( A , B ) = {\sum }_{vt ∈ Categories} {w}_{t} \cdot cos sim ( {A}_{t} , {B}_{t} ) .$$

Conventional systems are limited in that they define the occupations as vectors and must perform trigonometric calculations to compare and determine the similarities of two occupations. Consequently, a system that calculates the similarities of occupations without conducting trigonometric calculations is desired.

### BRIEF SUMMARY OF THE INVENTION

In accordance with the various features of the present invention, there is provided a system and method for quantifying and calculating a similarity between two occupations utilizing information provided by the Occupational Information Network (“the O*NET). More specifically, the system includes a processing device, an O*NET interface, and a user terminal interface. The O*NET interface is in communication with the O*NET. The O*NET rates each of a plurality of occupations with respect to each of a plurality of categories. Each of the categories includes a set of elements, whereby each element is rated in terms of a plurality of quantifying values. Accordingly, each of the plurality of occupations is rated in terms of the quantifying values with respect to each element of each of the plurality of categories.

The user terminal interface is in communication with a user terminal, such as a computer. A user operates the user terminal to select a first occupation and a second occupation from the plurality of occupations and to select a category from the plurality of categories. The user terminal then generates a request that indicates the first occupation, the second occupation, and the selected category and forwards the request to the system.

The processing device of the system receives the request by way of the user terminal interface and accesses the O*NET by way of the O*NET interface. The processing device utilizes the information provided by the O*NET and defines each of the plurality of occupations in terms of the quantifying values with respect to each element of the selected category. Next, the processing device calculates a numerical distance between the first occupation and each of the plurality of occupations, including the second occupation. The processing device then normalizes the distance between the first occupation and the second occupation and, finally, scales the normalized distance to generate a similarity value. The processing device transfers the similarity value to the user terminal, where the user terminal presents the similarity value such that it is perceivable by the user.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a block diagram of one embodiment of the system in accordance with the various features of the present invention; and

FIG. 2 is a flow diagram illustrating one embodiment of the method of calculating the similarity between the first occupation and the second occupation.

### DETAILED DESCRIPTION OF THE INVENTION

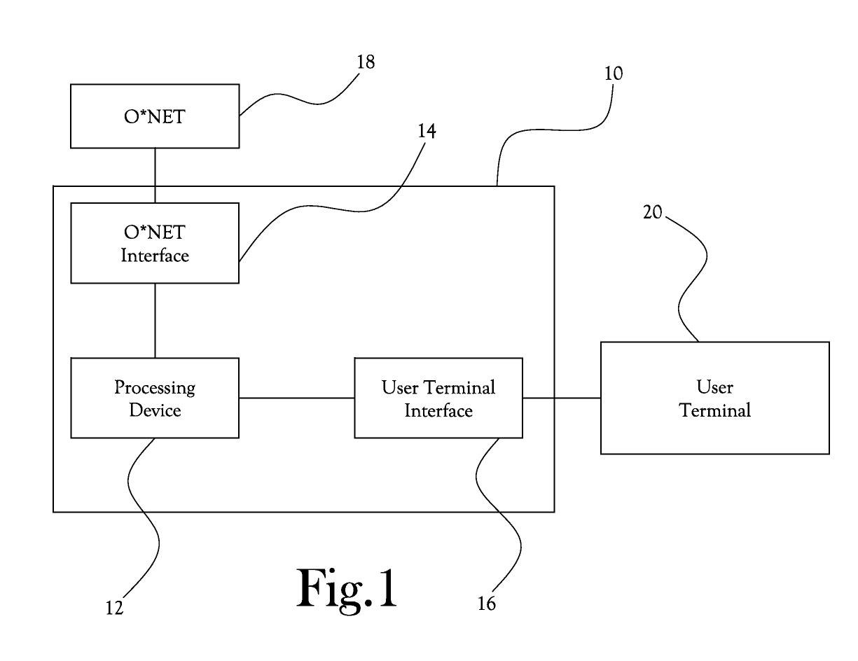

The present invention provides a system and method for quantifying and calculating a similarity between two occupations utilizing information provided by the Occupational Information Network (“the O*NET). More specifically, the system is in communication with the O*NET, which rates a plurality of occupations in terms of a plurality of quantifying values. The system accesses the quantifying values assigned to each of the two occupations and calculates the similarity therebetween. A block diagram of one embodiment of the system constructed in accordance with the various features of the present invention is illustrated generally at 10 in FIG. 1.

In the illustrated embodiment, the system 10 includes a processing device 12, an O*NET interface 14, and a user terminal interface 16, the processing device 12 being in electrical communication with the O*NET interface 14 and the user terminal interface 16. The system 10 is in communication with the O*NET 18 by way of the O*NET interface 14. In one embodiment, such communication is established by way of a network such as the Internet. The O*NET 18 is a primary source of occupation-based information in the United States and is maintained by the United States Department of Labor. The O*NET 18 maintains a database of information relating to a plurality occupations and rates each of these occupations in terms of quantifying values. More specifically, the O*NET 18 provides a plurality of categories that address various aspects of an occupation. For example, currently, the O*NET provides the following categories: Abilities, Skills, Interests, Knowledge, Tasks, Work Activities, Work Values, and Work Context. It should be noted that the categories currently provided by the O*NET can be added to, taken from, and altered without departing from the scope and spirit of the present invention. Within each category is a set of specific elements relating to that category. More specifically, the Abilities category includes a set of specific abilities, the Skills category includes a set of specific skills, the Interests category includes a set of specific interests, etc. For example, the Skills category includes the following set of elements, that is, specific skills.

1. Active Learning

2. Active Listening

3. Complex Problem Solving

4. Coordination

5. Critical Thinking

6. Equipment Maintenance

7. Equipment Selection

8. Installation

9. Instructing

10. Judgment and Decision Making

11. Learning Strategies

12. Management of Financial Resources

13. Management of Material Resources

14. Management of Personnel Resources

15. Mathematics

16. Monitoring

17. Negotiation

18. Operation Monitoring

19. Operation and Control

20. Operations Analysis

21. Persuasion

22. Programming

23. Quality Control Analysis

24. Reading Comprehension

25. Repairing

26. Science

27. Service Orientation

28. Social Perceptiveness

29. Speaking

30. Systems Analysis

31. Systems Evaluation

32. Technology Design

33. Time Management

34. Troubleshooting

35. Writing

The O*NET 18 rates each occupation in terms of the quantifying values with respect to each element of each category. More specifically, the quantifying values include an importance value im and a level value lv. The importance value im assigned to a particular element with respect to a particular occupation quantifies and indicates the importance of that element for that occupation. For example, when considering the elements of the Skills category, the importance value im assigned to a specific skill with respect to a particular occupation indicates the importance of that skill for that occupation. The current value range for the importance value im is 1 to 5. The level value lv assigned to a particular element with respect to a particular occupation quantifies and indicates the level of that element required by that occupation. For example, when considering the elements of the Skills category, the level value lv assigned to a specific skill with respect to a particular occupation indicates the level of that skill required by that occupation. The current value range for the level value lv is 0 to 7. It should be noted that the quantifying values include values other than the importance value im and the level value lv and that this does not affect the scope or spirit of the present invention. It should also be noted that the system 10 can be in communication with a database other than the O*NET without departing from the scope or spirit of the present invention if the other database includes the information utilized by the system 10.

In the illustrated embodiment, the system 10 is in communication with a user terminal 20 by way of the user terminal interface 16. The user terminal 20 is any device operable by user that enables the user to communicate bidirectionally with the system 10. In one embodiment, the user terminal 20 is a computer. In one embodiment, the system 10 is remotely hosted with respect to the user terminal 20, such as in the illustrated embodiment. In this embodiment, the system 10 is in communication with the user terminal 20 by way of, for example, a network such as the Internet. In such an embodiment, the user terminal 20 can communicate with the system 10 using a conventional web browser. In another embodiment, the system 10 is an integrated part of the user terminal 20. In this embodiment, the system 10 is, for example, a software installed at the user terminal 20, and the user terminal 20 is in communication with the O*NET by way of, for example, a network such as the Internet.

Operating the user terminal 20, the user generates a request for the calculation of a similarity between a first occupation and a second occupation with respect to a selected category. The first occupation and the second occupation are selected from the plurality of occupations provided by the O*NET, and the selected category is one of the plurality of categories provided by the O*NET. Accordingly, in one embodiment, the system 10 provides a list including the plurality of occupations and a list including the plurality of categories and presents each of the lists at the user terminal 20 such that the user selects the first occupation, the second occupation, and the selected category from the presented lists. The request indicates the first occupation, the second occupation, and the selected category as selected by the user. The user terminal 20 transfers the request to the system 10. Upon receiving the request, the system 10 calculates the similarity between the first occupation and the second occupation with respect to the selected category in accordance with the following discussion. However, it should be noted that in one embodiment, the system 10 automatically calculates the similarity between the first occupation and the second occupation with respect to each of the plurality of categories such that the user does not manually select the selected category but only selects the first occupation and the second occupation.

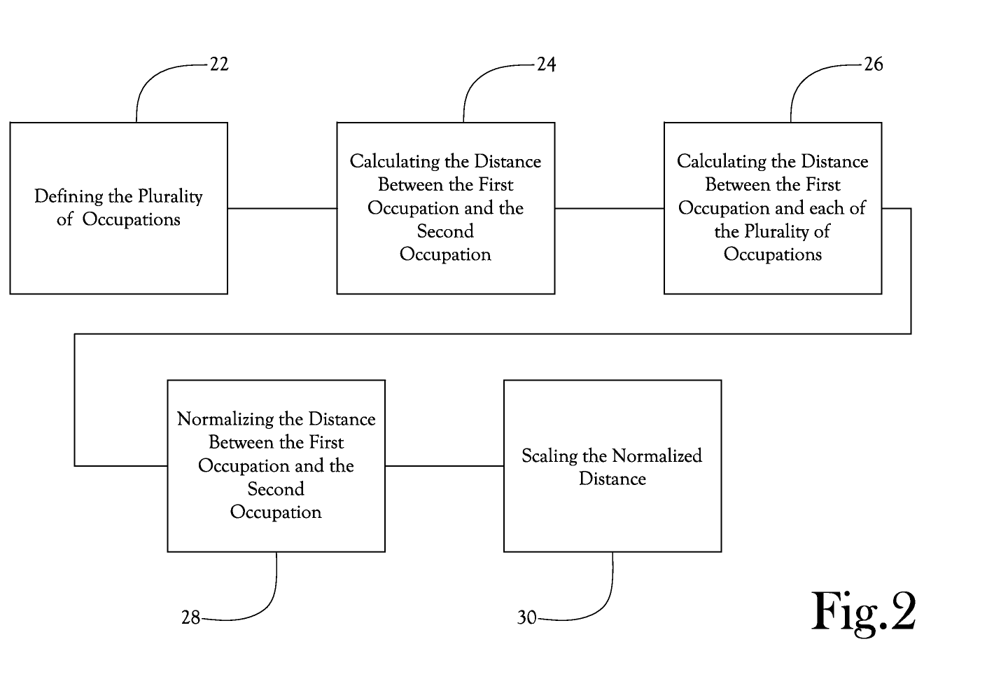

FIG. 2 is a flow diagram illustrating one embodiment of the method for calculating the similarity between the first occupation and the second occupation. Calculating the similarity between the first occupation and the second occupation includes numerically defining the occupations and calculating a numeric distance therebetween. Accordingly, the system 10 first defines each of the plurality of occupations in terms of the quantifying values, namely the importance value im and the level value lv, with respect to each element of the selected category, as is illustrated at 22. More specifically, each occupation, oᵢ, is defined in accordance with the following equation:

$${o}_{i} ( {element}_{n} ) = {( {lv}_{{element}_{n , {o}_{i}}} )}^{1.3} \cdot \frac{{im}_{{element}_{n , {o}_{i}}}}{{im}_{max}} ,$$

whereby, i identifies a particular one of the plurality of occupations, n identifies a particular one of the elements within the selected category,

$${im}_{{element}_{n , {o}_{i}}}$$

represents the importance value assigned to elementₙ with respect to oᵢ,

$${lv}_{{element}_{n , {o}_{i}}}$$

represents the level value assigned to elementₙ with respect to oᵢ, and imₘₐₓ, represents the maximum value possible for

$${im}_{{element}_{n , {o}_{i}}} .$$

Because the value range for

$${im}_{{element}_{n , {o}_{i}}}$$

is 1 to 5, as is discussed above, imₘₐₓ has a value of 5. Additionally, n ranges from 1 to T, T being the total number of elements within the selected category.

In view of the above discussion, the first occupation, o_{first}, is defined in accordance with the following equation, whereby o_{first} can be any of the plurality of occupations, namely o₁ to o_{N}, N being the total number of occupations within the plurality of occupations:

$${o}_{first} ( {element}_{n} ) = {( {lv}_{{element}_{n , {o}_{first}}} )}^{1.3} \cdot \frac{{im}_{{element}_{n , {o}_{first}}}}{{im}_{max}} .$$

Similarly, the second occupation, o_{second}, is defined in accordance with the following equation, whereby o_{second} can be any of the plurality of occupations, namely o₁ to o_{N}:

$${o}_{sec ond} ( {element}_{n} ) = {( {lv}_{{element}_{n , {o}_{sec ond}}} )}^{1.3} \cdot \frac{{im}_{{element}_{n , {o}_{sec ond}}}}{{im}_{max}} .$$

In view of the respective value range for each of

$${lv}_{{element}_{n , {o}_{i}}}$$

$$and$$

$${im}_{{element}_{n , {o}_{i}}} ,$$

as is provided by the O*NET, the value ranges for each of the plurality of occupations, namely o₁ through o_{N}, is 0 to 12.55.

After defining each of the plurality of occupations, the system 10 calculates the distance between the first occupation and the second occupation, as is illustrated at 24. More specifically, the system 10 calculates this distance by calculating the difference between the first occupation and the second occupation, as they are defined above, with respect to each element of the selected category and summing the resulting differences to generate a DistValueₒ_{_{first}}_{,o}_{_{second}}. This value is calculated in accordance with the following equation:

$${DistValue}_{{o}_{first} , {o}_{sec ond}} = {\sum }_{n = 1}^{T} {o}_{first} ( {element}_{n} ) - {o}_{sec ond} ( {element}_{n} ) ,$$

whereby, as discussed above, T represents the total number of elements within the selected category.

In addition to calculating the distance between the first occupation and the second occupation, the system 10 calculates the distance between the first occupation and each of the plurality of occupations, namely o₁ through o_{N}, resulting in a plurality of calculated distances, as is illustrated at 26. Each of these values is calculated in accordance with the following equation:

$${DistValue}_{{o}_{first} , {o}_{i}} = {\sum }_{n = 1}^{T} {o}_{first} ( {element}_{n} ) - {o}_{i} ( {element}_{n} ) ,$$

whereby i ranges from 1 to N, N, as discussed above, being the total number of occupations within the plurality of occupations.

The system 10 then normalizes the distance between the first occupation and the second occupation by dividing DistValueₒ_{_{first}}_{,o}_{_{second}} by the standard deviation of the set of values defined as DistValueₒ_{_{first}}_{,o}_{₁} through DistValueₒ_{_{first}}_{,o}_{_{N}}, as is illustrated at 28. The resulting value is NormalizedDistValueₒ_{_{first}}_{,o}_{_{second}} and is calculated in accordance with the following equation:

$${NormalizedDistValue}_{{o}_{first} , {o}_{sec ond}} = \frac{{DistValue}_{{o}_{first} , {o}_{sec ond}}}{\sqrt{\frac{1}{N} {\sum }_{i = 1}^{N} {( \begin{matrix}{DistValue}_{{o}_{first} , {o}_{i}} - \\ {DistValue}_{mean}\end{matrix} )}^{2}}} ,$$

whereby DistValueₘₑₐₙ is the mathematical mean of the set of values defined as DistValueₒ_{_{first}}_{,o}_{₁} through DistValueₒ_{_{first}}_{,o}_{_{N}}.

Finally, the system 10 scales the normalized distance between the first occupation and the second occupation using a multiplier of 10 to generate a value that represents the similarity between the first occupation and the second occupation, as is illustrated at 30. This value is SimilarityValueₒ_{_{first}}_{,o}_{_{second}} and is calculated in accordance with the following equation:

SimilarityValueₒ_{_{first}}_{,o}_{_{second}}=NormalizedDistValueₒ_{_{first}}_{,o}_{_{second}}·10.

The SimilarityValueₒ_{_{first}}_{,o}_{_{second}} has a value range of −10 to 10. The closer the SimilarityValueₒ_{_{first}}_{,o}_{_{second}} is to zero, the more similar the first occupation is to the second occupation. Accordingly, the SimilarityValueₒ_{_{first}}_{,o}_{_{second}} quantifies and is indicative of the similarity between the first occupation and the second occupation.

After calculating the similarity between the first occupation and the second occupation, namely the SimilarityValueₒ_{_{first}}_{,o}_{_{second}}, the system 10 transfers the calculated similarity to the user terminal 20 such that the user terminal 20 displays the similarity in a manner that is perceivable by the user.

In accordance with the above discussion, the selected category is one of the plurality of categories provided by the O*NET, which currently includes the Abilities, Interests, Knowledge, Tasks, Work Activities, Work Values, and Work Context categories. The system 10 calculates the similarity between the first occupation and the second occupation with respect to the Abilities, Skills, Knowledge, and Work Activities categories exactly as discussed and illustrated above. However, the quantifying values assigned to the Interests, Tasks, Work Values, and Work Context categories have value ranges different from those discussed above. Accordingly, the system 10 scales the above-discussed calculations to account for the differing value ranges and otherwise calculates the similarity between the first occupation and the second occupation with respect to the Interests, Tasks, Work Values, and Work Context categories as discussed and illustrated above.

The calculated similarity or the “gap” between two or more occupations has many applications. For example, an employee can utilize the calculated similarity between occupations to determine a suitable change in occupation or a suitable career path. A potential employee can utilize the calculated similarity between occupations to determine a suitable range of occupations within which to apply. And, an employer can utilize the calculated similarity between occupations to determine the suitability of applicants for an available position.

The calculated similarity between occupations is also useful in conjunction with other calculations and data manipulation. For example, the similarity between occupations can be used in conjunction with Job Zones, provided by the United States Department of Labor, Career Readiness Certificate Levels, determined from the National Career Readiness Certificates issued by various entities including ACT, Inc., and Career Clusters, provided by the United States Department of Education. For example, each Career Cluster includes a set of occupations, whereby the occupations of the set share certain commonalities. Similarly, occupations are grouped or classified into one of the Job Zones, whereby the classification is based on the education, experience, and training required of that group of occupations. Using this collective information, the system 10 calculates the educational requirements to satisfy a given occupational demand, generates career pathways that span from education to a desired occupation, analyzes and reports the economic and workforce condition of a given geographical region, including occupational and industry-based supply and demand, and provides strategic planning for economic and workforce development.

From the foregoing description, those skilled in the art will recognize that a system and method for quantifying and calculating a similarity between two occupations offering advantages over the prior art has been provided. More specifically, the system is in communication with the O*NET, which rates a plurality of occupations in terms of a plurality of quantifying values. The system accesses the quantifying values assigned to each of the occupations and calculates the similarity therebetween.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, what is claimed is:

1. A method for quantifying and calculating a similarity between a first occupation and a second occupation, the first occupation and the second occupation being of a plurality of occupations rated by the Occupational Information Network (O*NET), the similarity being calculated with respect to a selected one of a plurality of categories provided by the O*NET, the selected category including a set of elements, each of the set of elements being rated in terms of quantifying values, namely an importance value im and a level value lv, such that each of the plurality of occupations is rated in terms of the quantifying values with respect to each element of the selected category, said method comprising the steps of:
defining each of the plurality of occupations with respect to each element of the selected category in accordance with the following equation:
$${o}_{i} ( {element}_{n} ) = {( {lv}_{{element}_{n , {o}_{i}}} )}^{1.3} \cdot \frac{{im}_{{element}_{n , {o}_{i}}}}{{im}_{max}} ;$$
calculating a distance between the first occupation and each of the plurality of occupations, including the second occupation, in accordance with the following equation:
$${DistValue}_{{o}_{first} , {o}_{i}} = {\sum }_{n = 1}^{T} {o}_{first} ( {element}_{n} ) - {o}_{i} ( {element}_{n} ) ;$$
normalizing the distance between the first occupation and the second occupation in accordance with the following equation:
$${NormalizedDistValue}_{{o}_{first} , {o}_{sec ond}} = \frac{{DistValue}_{{o}_{first} , {o}_{sec ond}}}{\sqrt{\frac{1}{N} {\sum }_{i = 1}^{N} {( \begin{matrix}{DistValue}_{{o}_{first} , {o}_{i}} - \\ {DistValue}_{mean}\end{matrix} )}^{2}}} ;$$
$$and$$
scaling the normalized distance between the first occupation and the second occupation in accordance with the following equation:
SimilarityValueₒ_{_{first}}_{,o}_{_{second}}=NormalizedDistValueₒ_{_{first}}_{,o}_{_{second}}·10.

2. The method of claim 1 wherein i identifies a particular one of the plurality of occupations, n identifies a particular one of the elements within the selected category,
$${im}_{{element}_{n , {o}_{i}}}$$
represents the importance value assigned to elementₙ with respect to oᵢ,
$${lv}_{{element}_{n , {o}_{i}}}$$
represents the level value assigned to elementₙ with respect to oᵢ, imₘₐₓ represents the maximum value possible for
$${im}_{{element}_{n , {o}_{i}}} ,$$
T represents the total number of elements within the selected category, N represents the total number of occupations within the plurality of occupations, and distvalueₘₑₐₙ is the mathematical mean of the set of values resulting from said step of calculating a distance.

3. The method of claim 1 wherein the importance value im has a value range of 1 to 5 and the level value lv has a value range of 0 to 7.

4. The method of claim 3 wherein imₘₐₓ has a value of 5.

5. The method of claim 1 wherein the selected category is selected from the group of categories consisting of an Abilities category, a Skills category, an Interests category, a Knowledge category, a Tasks category, a Work Activities category, a Work Values category, and a Work Context category.

6. The method of claim 1 wherein the selected category is selected from the group of categories consisting of an Abilities category, a Skills category, a Knowledge category, and a Work Activities category.

7. A system that quantifies and calculates a similarity between a first occupation and a second occupation, said system comprising:
a database interface capable of communication with a database, the database rating each of a plurality of occupations with respect to each of a plurality of categories, each of the plurality of categories including a set of elements, each element being rated in terms of quantifying values such that each of the plurality of occupations is rated in terms of the quantifying values with respect to each element of each of the plurality of categories;
a user terminal interface capable of communication with a user terminal, the user terminal generates a request that indicates a first occupation, a second occupation, and a selected category, the first occupation and the second occupation being of the plurality of occupations, the selected category being of the plurality of categories; and
a processing device in electrical communication with said database interface and said user terminal interface, said processing device accesses the database and performs the following steps in response to receiving the request from the user terminal:
defining each of the plurality of occupations in terms of the quantifying values with respect to each element of the selected category;
calculating a distance between the first occupation and each of the plurality of occupations, including the second occupation;
normalizing the distance between the first occupation and the second occupation; and
scaling the normalized distance between the first occupation and the second occupation to generate a similarity value;
said processing device transfers the similarity value to the user terminal, the user terminal presents the similarity value such that it is perceivable by a user.

8. The system of claim 7 wherein the database is the Occupational Information Network (O*NET) maintained by the United States Department of Labor.

9. The system of claim 7 wherein the plurality of categories includes the following categories: Abilities, Skills, Interests, Knowledge, Tasks, Work Activities, Work Values, and Work Context.

10. The system of claim 7 wherein said system is remotely hosted with respect to the user terminal.

11. The system of claim 7 wherein said system is an integrated part of the user terminal.

12. The system of claim 11 wherein said system is a software installed at the user terminal.

13. The system of claim 7 wherein the user terminal generates the request when the user selects the first occupation, the second occupation, and the selected category by operating the user terminal.

14. The system of claim 7 wherein the quantifying values include an importance value im and a level value lv.

15. The system of claim 14 wherein said step of defining is performed in accordance with the following equation:
$${o}_{i} ( {element}_{n} ) = {( {lv}_{{element}_{n , {o}_{i}}} )}^{1.3} \cdot \frac{{im}_{{element}_{n , {o}_{i}}}}{{im}_{max}} .$$

16. The system of claim 15 wherein said step of calculating is performed in accordance with the following equation:
$${DistValue}_{{o}_{first} , {o}_{i}} = {\sum }_{n = 1}^{T} {o}_{first} ( {element}_{n} ) - {o}_{i} ( {element}_{n} ) .$$

17. The system of claim 16 wherein said step of normalizing is performed in accordance with the following equation:
$${NormalizedDistValue}_{{o}_{first} , {o}_{sec ond}} = \frac{{DistValue}_{{o}_{first} , {o}_{sec ond}}}{\sqrt{\frac{1}{N} {\sum }_{i = 1}^{N} {( \begin{matrix}{DistValue}_{{o}_{first} , {o}_{i}} - \\ {DistValue}_{mean}\end{matrix} )}^{2}}} .$$

18. The system of claim 17 wherein said step of scaling is performed in accordance with the following equation: SimilarityValueₒ_{_{first}}_{,o}_{_{second}}=NormalizedDistValueₒ_{_{first}}_{,o}_{_{second}}·10.

19. A method for quantifying and calculating a similarity between a first occupation and a second occupation, the first occupation and the second occupation being of a plurality of occupations rated by the Occupational Information Network (O*NET), the similarity being calculated with respect to a Skills categories provided by the O*NET, the Skills category including a set of specific skills, each of the specific skills being rated in terms of an importance value im and a level value lv such that each of the plurality of occupations is rated in terms of the importance value im and the level value lv with respect to each specific skill, said method comprising the steps of:
defining each of the plurality of occupations with respect to each specific skill in accordance with the following equation:
$${o}_{i} ( {skill}_{n} ) = {( {lv}_{{skill}_{n , {o}_{i}}} )}^{1.3} \cdot \frac{{im}_{{skill}_{n , {o}_{i}}}}{{im}_{max}} ;$$
calculating a distance between the first occupation and each of the plurality of occupations, including the second occupation, in accordance with the following equation:
$${DistValue}_{{o}_{first} , {o}_{i}} = {\sum }_{n = 1}^{T} {o}_{first} ( {skill}_{n} ) - {o}_{i} ( {skill}_{n} ) ;$$
normalizing the distance between the first occupation and the second occupation in accordance with the following equation:
$${NormalizedDistValue}_{{o}_{first} , {o}_{sec ond}} = \frac{{DistValue}_{{o}_{first} , {o}_{sec ond}}}{\sqrt{\frac{1}{N} {\sum }_{i = 1}^{N} {( \begin{matrix}{DistValue}_{{o}_{first} , {o}_{i}} - \\ {DistValue}_{mean}\end{matrix} )}^{2}}} ;$$
and
scaling the normalized distance between the first occupation and the second occupation in accordance with the following equation:
SimilarityValueₒ_{_{first}}_{,o}_{_{second}}=NormalizedDistValueₒ_{_{first}}_{,o}_{_{second}}·10.

20. The method of claim 19 wherein i identifies a particular one of the plurality of occupations, n identifies a particular one of the specific skills,
$${im}_{{skill}_{n , {o}_{i}}}$$
represents the importance value assigned to skillₙ with respect to oᵢ,
$${lv}_{{skill}_{n , {o}_{i}}}$$
represents the level value assigned to skillₙ with respect to oᵢ, imₘₐₓ represents the maximum value possible for
$${im}_{{skill}_{n , {o}_{i}}} ,$$
T represents the total number of specific skills, N represents the total number of occupations within the plurality of occupations, and distvalueₘₑₐₙ is the mathematical mean of the set of values resulting from said step of calculating a distance.

21. The method of claim 19 wherein the importance value im has a value range of 1 to 5 and the level value lv has a value range of 0 to 7.

22. The method of claim 21 wherein imₘₐₓ has a value of 5.
